(19) United States
(12) Patent Application Publication
(10) Pub. No.: US 2009/0068546 A1
(43) Pub. Date: Mar. 12, 2009

(54) Particle containing carbon particle, platinum and ruthenium oxide, and method for producing same

(76) Inventors: Yoshinori Sato, Osaka (JP); Yuko Sawaki, Osaka (JP); Yasuo Arishima, Osaka (JP)

Correspondence Address: BIRCH STEWART KOLASCH & BIRCH, PO BOX 747, FALLS CHURCH, VA, 22040-0747, US

(21) Appl. No.: 11/918,774

(22) PCT Filed: Mar. 9, 2006
(86) PCT No.: PCT/JP2006/304587

§ 371 Date: Oct. 18, 2007

(30) Foreign Application Priority Data
Apr. 21, 2005 (JP) 2005-123978

(51) Int. Cl. H01M 4/86; B05D 5/12; B32B 5/16

(52) U.S. Cl. 429/44; 427/214; 428/402

(57) ABSTRACT

The present invention relates to particles comprising at least carbon particles, platinum and ruthenium oxide, wherein the carbon particles support platinum and ruthenium oxide having an average particle diameter of 1 nm or less, and a method for producing the same, and to a power generating element for a fuel cell in which the particles are used as a catalyst for an electrode.

### TECHNICAL FIELD

This patent application claims priority on Japanese Patent Application No. 2005-123978, the entire disclosure of which is herein incorporated by reference.

The present invention relates to particles comprising carbon particles, platinum and ruthenium oxide, and method for producing the same

### BACKGROUND ART

A material obtained by supporting fine metal compound particles on carbon as a carrier has hitherto been known as a useful functional material. Also, materials obtained by supporting metal particles, alloy particles and metal oxide particles on carrier particles is widely used as catalysts for various purposes such as electrodes of fuel cells, purification of an automobile exhaust, and NOx reduction. In this case, as carrier particles, metal oxides such as titanium oxide, zirconium oxide, iron oxide, nickel oxide, and cobalt oxide are used, in addition to carbon.

Such a material obtained by supporting fine metal compound particles of an alloy or a metal oxide on carrier particles can be produced, for example, by the following liquid phase methods:

(1) A method of adsorbing metal colloidal particles on a carrier;
(2) A method of dispersing carrier particles in an aqueous metal salt solution and depositing a metal hydroxide on the surface of the carrier using an alkali chemical; and
(3) A method of fixing fine particles on the surface of a carrier from a fine particle dispersion containing fine particles dispersed therein in advance.

Methods using these liquid phase methods are disclosed in Japanese Patent Unexamined Publication (Kokai) No. 5-217586 (Patent Literature 1) and Japanese Patent Unexamined Publication (Kokai) No. 2000-36303 (Patent Literature 2). Of these methods, in the method disclosed in Japanese Patent Unexamined Publication (Kokai) No. 5-217586, carbon particles comprising platinum supported thereon in advance are dispersed in a mixture of another predetermined metal salt using an alkali chemical and a hydroxide of the metal is deposited on the carbon particles, and then fine alloy particles (fine alloy particles composed of four elements such as platinum, molybdenum, nickel, and iron) are supported on the carbon particles by heating to 1000° C. or higher under a reducing atmosphere. In the patent document, there is described that the particle size of fine alloy particles supported on the carbon particles is about 3 nm or more.

In the method disclosed in Japanese Patent Unexamined Publication (Kokai) No. 2000-36303, when particles comprising vanadium pentoxide supported on carbon are produced, an organovanadium solution is solvated by adding an organic solvent to prepare an organic complex, and then the organic complex is adsorbed and supported on carbon. In this case, vanadium pentoxide supported on carbon is amorphous.

As a catalyst of a direct methanol type fuel cell which is expected to be used as a power supply for a portable terminal, or a solid polymer type fuel cell in which reformed hydrogen is utilized, a platinum-ruthenium alloy is widely used at present. In this case, it is known that ruthenium functions as a promoter capable of increasing catalytic ability of platinum and more excellent catalytic ability is exhibited when a platinum-ruthenium alloy is used as-compared with the case where only metallic platinum is used as a catalyst (Journal of Electroanalytical Chemistry Vol. 60, pp. 267-273 (1975): Non-Patent Literature 1).

Furthermore, Japanese Patent Unexamined Publication (Kokai) No. 2004-283774 (Patent Literature 3) discloses that a highly dispersed nano-size catalyst is prepared by supporting RuO₂ on Pt/C as a catalyst carrier to obtain a catalyst for a fuel cell, which exhibits high activity. The same patent document also discloses a method of supporting RuO₂ on a catalyst carrier by bringing an RuO₄ gas generated by adding an oxidizer of an aqueous solution of an Ru compound into contact with the catalyst carrier, or bringing a solution obtained by vaporizing a solution containing RuO₄ into contact with the catalyst carrier, and vaporizing the solvent remaining in the catalyst carrier. The same patent document describes that the same performances as those of a platinum-ruthenium alloy can be achieved while reducing the amount of ruthenium to be supported by the use of a Pt—RuO₂ type catalyst for a fuel cell in place of a conventional Pt—Ru type catalyst, namely, the use of fine ruthenium oxide particles.

However, the particle size of the resulting catalyst is entirely from about 1 to 3 nm, that is, the average particle diameter is more than 1 nm.

Patent Literature 1: Japanese Patent Unexamined Publication (Kokai) No. 5-217586

Patent Literature 2: Japanese Patent Unexamined Publication (Kokai) No. 2000-36303 Non-Patent Literature 1: Journal of Electroanalytical Chemistry Vol. 60, pp. 267-273 (1975)

Patent Literature 3: Japanese Patent Unexamined Publication (Kokai) No. 2004-283774

### SUMMARY OF THE INVENTION

However, when the catalyst is produced by the method (1) or (3) described above, metal colloidal particles or fine particles are aggregated before supporting on the carrier, and thus metal particles to be supported are grown. Also, when the catalyst is produced by the method (2), it is difficult to deposit on the surface of the carrier while maintaining a uniform dispersion state until primary particles, and thus the particle diameter of the deposited metal hydroxide increases. Therefore, the metal compound-supporting particles obtained by using these methods do not have sufficient surface area of the supported fine metal compound particles, and satisfactory activity cannot be achieved when used as the catalyst or the like.

As described above, the fine particles to be supported on a carrier so as to impart a catalytic function are often fine metal particles or fine alloy particles, and are aggregated before supporting on the carrier, and thus fine particles to be supported are grown. Alternatively, it is difficult to deposit on the surface of the carrier while maintaining a uniform dispersion state until primary particles, and thus the particle diameter of the deposited metal hydroxide is likely to increase. Therefore, in a conventional method, it was very difficult to support fine metal oxide particles or fine metal hydroxide particles on carrier particles in the state where these particles have sufficient surface area.

In a fuel cell catalyst for a power supply which is used for a portable terminal, there has never been obtained a substance which is identical to or superior to ruthenium as a promoter. However, ruthenium is a metal which is expensive similar to platinum and also has more severe restrictions on the amount of resources than platinum. In the case where an alloy of platinum and ruthenium is used in the electrode, the function thereof does not reach a satisfactory degree in ethanol oxidation.

In light of these circumstances, an object of the present invention is to provide fine platinum and ruthenium oxide particles-supporting carbon particles comprising fine ruthenium oxide particles having an average particle diameter of 1 nm or less while maintaining a monodispersed state until primary particles, and a method for producing the same.

The present inventors have intensively studied so as to achieve the above object and found that particles comprising at least carbon particles, platinum and ruthenium oxide have high activity in methanol oxidation. The present inventors have also found that fine metal oxide particles can be supported on carbon while maintaining a monodispersed state until primary particles by synthesizing complex ions of ruthenium and adsorbing complex ions on the surface of carbon particles. Thereby, the present inventors have succeeded in developing carbon particles for supporting platinum and ruthenium oxide, comprising fine ruthenium oxide particles having an average particle diameter of 1 nm or less supported thereon, which have never been obtained by a conventional method.

Namely, the present invention relates to particles including at least carbon particles, platinum and ruthenium oxide, wherein the carbon particles have an average particle diameter of 20 to 70 nm and also the carbon particles support platinum and ruthenium oxide having an average particle diameter of 1 nm or less.

Also, the present invention relates to a power generating element for a fuel cell including the particles of the present invention as a catalyst for an electrode.

Furthermore, the present invention relates to a method for producing the particles of the present invention, which comprises a step of dispersing platinum-supporting carbon particles comprising platinum having an average particle diameter of 1 to 5 nm supported on carbon particles having an average particle diameter of 20 to 70 nm in a solution containing complex ions of ruthenium, thereby adsorbing complex ions of ruthenium on the platinum-supporting carbon particles.

### BRIEF DESCRIPTION OF THE DRAWINGS

FIG. 1 is a sectional view showing an example of a power generating element for a fuel cell of the present invention.

FIG. 2 is a schematic sectional view showing a unit cell for evaluation of a fuel cell.

### BRIEF DESCRIPTION OF REFERENCE NUMERALS

1 Positive electrode
2 Solid polymer electrolyte membrane
3 Negative electrode
5 Power generating element for fuel cell
6 Diffusion layer
7 Seal material
8 Positive electrode current collector plate
9 Negative electrode current collector plate
10 Oxygen flow-in port
11 Fuel supply port
12 Fuel tank
13 Liquid fuel

### BEST MODE FOR CARRYING OUT THE INVENTION

The particles of the present invention include at least carbon particles, platinum and ruthenium oxide, wherein the carbon particles have an average particle diameter of 20 to 70 nm and also the carbon particles support platinum and ruthenium oxide having an average particle diameter of 1 nm or less.

The particles of the present invention are carbon particles which support platinum and ruthenium oxide thereon, as described above, and the particles can further include, in addition to carbon particles, platinum and ruthenium oxide, cerium oxide for the purpose of improving activity of a platinum catalyst.

In the particles of the present invention, the amount of ruthenium oxide supported on the carbon particles is preferably from 1 to 25% by weight because the particle diameter, particularly the average particle diameter of ruthenium oxide can be maintained to a small size, particularly 1 nm or less, and ruthenium oxide does not pile up on the surface of platinum existing on carbon particles and thus platinum can be effectively used to the fullest extent. The support amount of ruthenium oxide is more preferably 3% by weight or more and 20% by weight or less, and still more preferably 5% by weight or more and 10% by weight or less.

In the particles of the present invention, the amount of platinum supported on the carbon particles is preferably from 1 to 50% by weight because it becomes possible to support nano-size platinum on carbon particles nearly uniformly.

The average particle diameter of ruthenium oxide to be supported on the particles of the present invention is 1 nm or less. When the average particle diameter is more than 1 nm, sufficient surface area per weight of ruthenium oxide is not attained and catalytic activity per weight of ruthenium oxide becomes insufficient as compared with those having an average particle diameter of 1 nm or less. As the average particle diameter decreases, the surface area of the supported ruthenium oxide increases and catalytic activity tends to increase. Therefore, the average particle diameter is preferably 1 nm or less, and more preferably 0.8 nm or less. In contrast, when the average particle diameter is too small, catalytic activity becomes lower and thus the average particle diameter is preferably 0.1 nm or more.

The average particle diameter of platinum to be supported on the particles of the present invention is preferably from 1 to 5 nm because sufficient surface area is obtained and high catalytic activity is obtained, and also the particle diameter of platinum particles is too small and thus the surface of the platinum particles is not partially oxidized. The average particle diameter is more preferably from 2 to 5 nm, and still more preferably from 3 to 4.5 nm.

Platinum and ruthenium oxide to be supported on the particles of the present invention may preferably exist in the form of fine particles, and also may exist in the state where a portion or all of the ruthenium in fine particles based on an alloy of platinum and ruthenium are oxidized. In this case, the average particle diameter of the fine particles containing ruthenium oxide corresponds to that of ruthenium oxide in the present invention.

The average particle diameter of carbon particles comprising platinum and ruthenium oxide supported thereon of the present invention is preferably within a range from 10 to 80 nm after supporting because fuel diffusion when used as a power generating element for a fuel cell and flowability of the coating material upon production of an electrode are improved. The average particle diameter is more preferably within a range from 20 to 80 nm.

Specific examples of the method for producing the particles of the present invention will now be described.

To produce the particles of the present invention, first, a solution containing complex ions of ruthenium metal is prepared in advance and carbon particles comprising platinum supported thereon in advance are dispersed in the solution, thereby adsorbing complex ions of ruthenium on the surface of the platinum-supporting carbon particles.

In the preparation of the solution containing complex ions of ruthenium metal, complex ions of inorganic matter complexes such as a chloride complex, a hydrate complex, an amine complex, and an amine nitrate complex; and complexes containing an organic matter, such as a citric acid complex, a carboxylic acid complex, and a picolinic acid complex can be given as examples of the complex ions of ruthenium.

Of these complex ions, complex ions of a chloride complex, a citric acid complex and a picolinic acid complex are preferred in view of good efficiency of adsorption on the surface of carbon.

Next, carbon particles are dispersed in the solution containing complex ions of ruthenium. When doing so, fine platinum particles may be supported in advance on the carbon particles to be dispersed, or fine platinum particles may be supported after supporting ruthenium oxide.

The method for supporting fine platinum particles on the surface of carbon particles is not specifically limited and a known method such as a solution reduction method can be applied. In the case where fine platinum particles are supported by the reduction method, the fine platinum particles are preferably supported before supporting ruthenium oxide.

The average particle diameter of the fine platinum particles supported on the carbon particles is preferably from 1 to 5 nm. Although it is expected that catalytic ability is improved when the average particle diameter of the fine platinum particles become smaller, it is very difficult to produce platinum-supporting carbon particles comprising fine platinum particles having a particle diameter of 1 nm or less supported thereon at present. There arises no problem when the average particle diameter is larger than 5 nm, however, catalytic ability may become lower.

Examples of the carbon particles on which fine platinum particles are supported include carbon particles such as an acetylene black, for example, DENKA BLACK® manufactured by DENKI KAGAKU KOGYO KABUSHIKI KAISYA CO., LTD., a furnace carbon, for example, Vulcan (trade name) manufactured by CABOT Corp., and ketjen black. It is preferred to support 1 to 50% by weight of fine platinum particles on these carbon particles. When the support amount of fine platinum particles is too small, catalytic ability sometimes becomes lower. Also, when the support amount of fine platinum particles is too large, since the area occupied by the fine platinum particles relative to the surface area of the carbon particles becomes too large, the fine platinum particles may be superposed on each other to cause aggregation. The support amount of the fine platinum particles is preferably from 20 to 50% by weight based on the carbon particles.

Carbon particles comprising platinum supported thereon are commercially available and, for example, an acetylene black such as DENKA BLACK® manufactured by DENKI KAGAKU KOGYO KABUSHIKI KAISYA CO., LTD. and a furnace carbon such as Vulcan (trade name) manufactured by CABOT Corp. can be preferably used.

The platinum-supporting carbon particles are preferably dispersed in the solution containing ruthenium complex ions such that the amount of metal elements contained in the solution is within a range from 1 to 25% by weight in terms of the amount of a metal oxide (ruthenium oxide) as a final form based on the fine particles-supporting carbon particles as a final product. When the support amount of the fine ruthenium oxide particles in the fine particles-supporting carbon particles as the final product is less than 1% by weight, the function of a promoter of the fine platinum particles may be less likely to be exhibited. When the support amount of the fine ruthenium oxide particles is more than 25% by weight, there is a fear that the fine ruthenium oxide particles are not deposited on the surface of the carbon particles in the form of a single layer and thus the fine ruthenium oxide particles are superposed on each other to cause aggregation.

Next, ruthenium oxide is supported on carbon particles, for example, by subjecting platinum-supporting carbon particles containing complex ions of ruthenium adsorbed thereon to an oxidation treatment in a liquid phase using an oxidizer and/or a drying treatment.

It is particularly preferred that fine ruthenium oxide particles are deposited on the surface of carbon by drying platinum-supporting carbon particles containing complex ions of ruthenium adsorbed thereon to produce fine particles-supporting carbon particles.

As described above, the fine ruthenium oxide particles can be deposited on the surface of the platinum-supporting carbon particles by preferably adsorbing complex ions of ruthenium on the surface of the platinum-supporting carbon particles, followed by filtration and further drying. The ruthenium complex to be adsorbed on the surface of the platinum-supporting carbon is the form of ions and is dispersed in the solution in a molecular level, and thus the ruthenium complex can be adsorbed on the adsorption site of carbon while maintaining the dispersion state. Since only most adjacent complexes are crystallized in the case of drying, fine ruthenium oxide particles having a particle diameter of 1 nm or less can be deposited. The drying atmosphere is not specifically limited, and it is preferred to dry in air because this operation is conducted most simply and at a low cost.

Furthermore, the thus obtained fine particles-supporting carbon particles may be subjected to a heat treatment. For example, the heat treatment may be conducted in air or nitrogen so as to transform the supported fine particles into a metal oxide having specific valencies. The heat treatment is preferably conducted at a temperature of 300° C. or lower so as not to carbonize carbon.

As described above, the present invention relates to a method for producing particles according to the present invention, which includes a step of dispersing platinum-supporting carbon particles comprising platinum having an average particle diameter of 1 to 5 nm supported on carbon particles having an average particle diameter of 20 to 70 nm in a solution containing complex ions of ruthenium, thereby adsorbing complex ions of ruthenium on the platinum-supporting carbon particles.

Also, the present invention relates to the above method, which further comprises a step of drying the platinum-supporting carbon particles, thereby depositing fine ruthenium oxide particles on the surface of the platinum-supporting carbon particles.

Namely, it becomes possible to obtain particles in which fine ruthenium oxide particles having an average particle diameter of 1 nm or less are supported on a carbon carrier while maintaining a monodispersed state until primary particles, which have never been obtained by a conventional method, by the above method of adsorbing complex ions of a metal on the surface of carbon particles.

The resulting fine particles-supporting carbon particles of the present invention can be used as, in addition to electrode catalysts for a fuel cell, antistatic agents for a magnetic recording medium, and various catalysts for automobile exhaust purification.

Next, as an aspect for evaluation of catalytic characteristics of the carbon particles comprising fine platinum and ruthenium oxide particles supported thereon, a power generating element for a fuel cell for evaluation of fuel oxidizing ability of a fuel cell will be described with reference to an accompanying drawing.

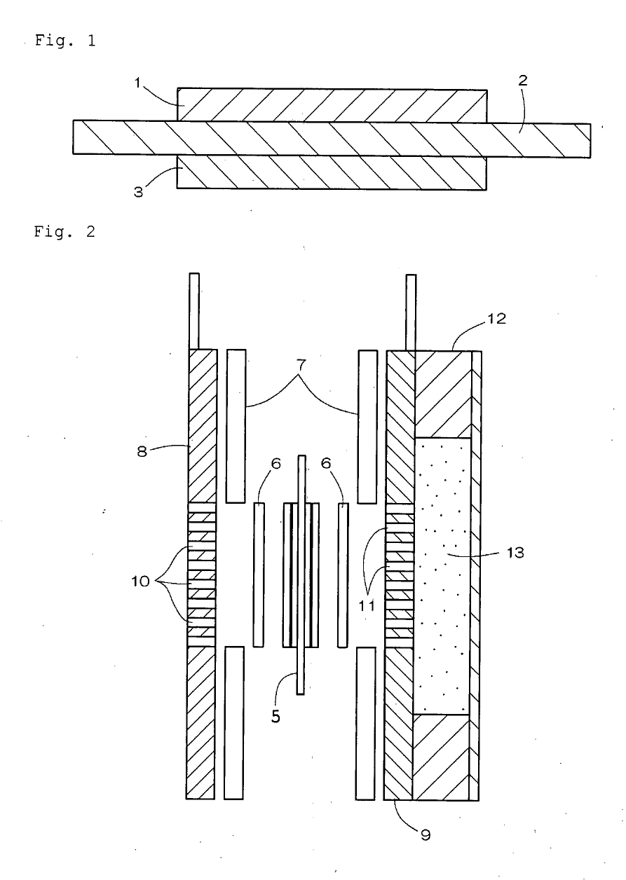

FIG. 1 is a schematic sectional view showing an example of a power generating element for a fuel cell. In FIG. 1, this power generating element for a fuel cell comprises a positive electrode 1 which reduces oxygen, a negative electrode 3 which oxidizes a fuel, and a solid polymer electrolyte membrane 2 provided between the positive electrode 1 and the negative electrode 3.

The negative electrode layer 3 can be composed of a catalyst, a conductive material, a polymer material, and the like. As the catalyst contained in the negative electrode layer, those having a function capable of producing protons from the fuel, namely, those having a function capable of electrochemically oxidizing the fuel can be used. For example, it is possible to use fine platinum particles alone, or fine alloy particles composed of platinum, and ruthenium, indium, iridium, tin, iron, titanium, gold, silver, chromium, silicon, zinc, manganese, molybdenum, tungsten, rhenium, aluminum, lead, palladium, osmium, or the like. As the conductive material, a carbon material is mainly used. For example, carbon black, activated carbon, a carbon nanotube, and a carbon nanohorn are used. In general, the fine particles are used in the state of a catalyst-supporting carbon where the above catalyst is dispersed and supported on the surface of the conductive material.

Furthermore, the negative electrode layer 3 sometimes contains, as a binder, a polytetrafluoroethylene (PTFE) resin, a polyvinylidene fluoride (PVDF) resin, a polyethylene (PE) resin, or the like.

The positive electrode layer 1 can be composed of a catalyst, a conductive material, a polymer material, and the like. As the catalyst contained in this positive electrode layer, those having a function capable of electrochemically reducing oxygen can be used. For example, fine platinum particles, and fine alloy particles of iron, nickel, cobalt, tin, ruthenium or gold and platinum are used. The conductive material, the polymer material, and the binder, which can be used, may be the same as those used in the negative electrode.

The power generating element for a fuel cell comprising the particles of the present invention as a catalyst for an electrode can exhibit excellent power characteristics suited for use as a fuel cell as compared with a conventional power generating element. When the particles of the present invention are used as a catalyst for a negative electrode, a particularly remarkable effect is exerted. It is also preferred that the particles of the present invention are used as the catalyst for the negative electrode and the positive electrode, if necessary.

A solid polymer electrolyte membrane 2 disposed between a positive electrode 1 and a negative electrode 3 is composed of a material which has no electron conductivity and only has proton conductivity. It is possible to use a polyperfluorosulfonic acid resin film, for example, specifically a film such as “Nafion” (trade name) manufactured by E. I. du Pont de Nemours and Co., “Flemion®” manufactured by Asahi Glass Co., Ltd., or “Aciplex” (trade name) manufactured by Asahi Kasei Corporation can be used. Further examples of the film include a sulfonated polyethersulfonic acid resin film, a sulfonated polyimide resin film, a sulfonic acid-doped polybenzimidazole film, a phosphoric acid-doped SiO₂ film known as a solid electrolyte, a hybrid film made of a polymer and a solid electrolyte, and a gel electrolyte film obtained by impregnating a polymer and an oxide with an acidic solution.

Subsequently, an example of the method for producing a power generating element for a fuel cell of the present invention will be described.

First, an electrode paste used to form a fuel electrode layer is prepared. This electrode paste can be prepared by dissolving or dispersing a catalyst, a conductive material, a polymer material and, if necessary, a binder in a solvent containing a lower alcohol such as ethanol or propanol as a main component, and sufficiently stirring the solution.

Separately, a releasable substrate is prepared. As the releasable substrate, for example, a PTFE film, a PET film, a polyimide film, a PTFE coated polyimide film, a PTFE coated silicon sheet, and a PTFE coated glass cloth can be used.

Next, the electrode paste is applied on the releasable substrate and dried to form an electrode layer. The thickness of the thus formed electrode layer is preferably controlled within a range from 10 to 50 μm, whereby, the porous structure and structural integrity of the electrode layer are not impaired and also the amount of the catalyst can be ensured to some extent. Also, the amount of the catalyst (mass per unit electrode area) contained in the electrode layer is preferably controlled within a range from 0.3 to 3 mg/cm². When the amount of the catalyst is within the above range, the required amount of the catalyst can be ensured without increasing the total number of the electrode layer.

Next, the electrode layer formed on the releasable substrate is peeled off and then cut into pieces each having a predetermined electrode size.

Subsequently, a dry powder used to produce an oxygen reduction electrode is prepared. This dry powder can be prepared by dissolving or sufficiently dispersing a catalyst, a conductive material, a polymer material and, if necessary, a binder in a solvent containing a lower alcohol such as ethanol or propanol as a main component, followed by drying.

The dry powder is formed into pellets each having a specific electrode size as with the negative electrode mentioned above, and the resulting pellets are used as an oxygen reduction electrode.

Next, the electrode layer is bonded on both surfaces of a solid polymer electrolyte membrane using a hot press or a hot roll press to obtain a power generating element for a fuel cell.

In the power generating element for a fuel cell, a diffusion layer is provided on both sides of the positive electrode and the negative electrode, and each of the positive electrode and the negative electrode is provided with a current collector plate, thereby performing electrical connection, and then a liquid fuel containing methanol is supplied to the negative electrode and air (oxygen) is supplied to the positive electrode, and thus the resulting product can function as a fuel cell.

Main embodiments and preferred embodiments of the present invention will now be listed.

[1] Particles including at least carbon particles, platinum and ruthenium oxide, wherein the carbon particles support platinum and ruthenium oxide having an average particle diameter of 1 nm or less.
[2] The particles according to [1], wherein the amount of ruthenium oxide supported on the carbon particles is from 1 to 25% by weight.
[3] The particles according to [1] or [2], wherein the amount of platinum supported on the carbon particles is from 1 to 50% by weight.
[4] The particles according to any one of [1] to 3, wherein the platinum has an average particle diameter of 1 to 5 nm.
[5] The particles according to any one of [1] to [4], wherein the carbon particles have an average particle diameter of 20 to 70 nm.
[6] The particles according to any one of [1] to [5], which have the average particle diameter of 10 to 80 nm.
[7] A power generating element for a fuel cell, comprising the particles according to any one of [1] to [6] as a catalyst for an electrode.
[8] The power generating element for a fuel cell according to the [7], wherein the electrode is at least a negative electrode.
[9] The power generating element for a fuel cell according to the paragraph [7], wherein the electrode includes a negative electrode and a positive electrode.
[10] A method for producing the particles according to any one of [1] to [6], which includes a step of dispersing platinum-supporting carbon particles including platinum having an average particle diameter of 1 to 5 nm supported on carbon particles having an average particle diameter of 20 to 70 nm in a solution containing complex ions of ruthenium, thereby adsorbing complex ions of ruthenium on the platinum-supporting carbon particles.
[11] The method according to the paragraph [10], which further comprises a step of drying the platinum-supporting carbon particles, thereby depositing fine ruthenium oxide particles on the surface of the platinum-supporting carbon particles.

### EXAMPLES

The present invention will now be described in detail by way of Examples. The present invention disclosed above is not limited to the following Examples without departing from the spirit and the technical scope of the present invention. Those skilled in the art can easily adopt known modifications and conditions based on the following description.

### Example 1

1.35 g of ruthenium chloride was dissolved in 300 ml of water and picolinic acid was added in an amount of 2 equivalents based on ruthenium ions to prepare an aqueous solution containing picolinic acid complex ions of ruthenium.

Next, 3.0 g of a platinum-supporting carbon “10E50E” (trade name), as a catalyst, comprising 50% by mass of platinum having a particle diameter of 4 to 5 nm in terms of a nominal value supported thereon manufactured by Tanaka Kikinzoku Kogyo Co., Ltd. was added to the aqueous solution containing picolinic acid complex ions of ruthenium. After dispersing the platinum-supporting carbon with ultrasonic waves and stirring for 2 hours, the complex ions were adsorbed on the surface of carbon. The dispersion solution was allowed to stand for about 24 hours, filtered, washed and then dried at 90° C. to obtain platinum-supporting carbon particles comprising a ruthenium compound supported thereon. Furthermore, the resulting platinum-supporting carbon particles were subjected to a heat treatment in air at 270° C. to obtain carbon particles comprising platinum and ruthenium oxide supported thereon.

With respect to the carbon particles comprising platinum and ruthenium oxide supported thereon, transmission electron microscope (TEM) observation was conducted. The results revealed that fine ruthenium oxide particles having a particle diameter of about 0.6 to 0.8 nm are supported on the surface of the carbon particles. The results of fluorescent X-ray analysis revealed that the support amount of ruthenium oxide is 4.07% by weight. The average particle diameter and each support amount of the fine ruthenium oxide particles and the fine platinum particles are shown in Table 1.

Subsequently, a direct methanol type fuel cell was produced using the thus obtained carbon particles comprising platinum and ruthenium oxide supported thereon.

A power generating element for a fuel cell having the same structure as that shown in FIG. 1 was produced by the following procedure.

With respect to a positive electrode, 1 part by mass of a platinum-supporting carbon “10E50E” (trade name), as a catalyst, comprising 50% by mass of platinum supported thereon manufactured by Tanaka Kikinzoku Kogyo Co., Ltd. was added to 12 parts by mass of a “Nafion” (trade name, EW=1,000) solution as a 5 mass % solution of a polyperfluorosulfonic acid resin manufactured by Aldrich Corp and 1 part by mass of water. Then, the mixture was stirred so as to be uniformly dispersed and dried to obtain a dry powder, which was formed into pellets each having a platinum support amount of 5.0 mg/cm². EW means the equivalent mass of ion exchange groups having proton conductivity (sulfonic acid groups in this Example). The equivalent mass is a dry mass of an ion exchange resin per 1 equivalent of ion exchange groups and is expressed by the unit “g/ew”.

With respect to a negative electrode, 1 part by mass of aforementioned carbon particles, as a catalyst, comprising platinum and ruthenium oxide supported thereon was added to 9.72 parts by mass of a “Nafion” (trade name, EW=1,000) solution as a 5 mass % solution of a polyperfluorosulfonic acid resin manufactured by Aldrich Corp., 2.52 parts by mass of “Nafion®” as a 20 mass % solution of a polyperfluorosulfonic acid resin manufactured by E.I. du Pont de Nemours and Co. and 1 part by mass of water and the mixture was sufficiently stirred so as to be uniformly dispersed-to prepare an electrode paste.

Next, the electrode paste was applied on a PTFE film and dried, and the thus formed layer was peeled off to obtain an electrode layer in which the support amount of platinum is 2.0 mg/cm² and the support amount of ruthenium oxide is 0.21 mg/cm² (calculated as metallic ruthenium: 0.167 mg/cm²)

As the solid polymer electrolyte membrane (hereinafter referred to as an electrolyte film), a polyperfluorosulfonic acid resin film “Nafion® 112” manufactured by E.I. du Pont de Nemours and Co.) was used after cutting into pieces having a predetermined size.

On both surfaces of this electrolyte film, a positive electrode layer and a negative electrode layer formed in advance were superposed on each other in a state of facing each other, while facing the electrode surface to the side of the electrolyte film, and a hot press was conducted under the conditions of a temperature of 160° C. and a pressure of 4.4 MPa, thereby bonding them.

### Example 2

In the same manner as in Example 1, except that the amount of ruthenium chloride used to prepare the aqueous solution containing picolinic acid complex ions of ruthenium was 3.60 g, carbon particles comprising platinum and ruthenium oxide supported thereon were obtained.

With respect to the thus obtained carbon particles comprising platinum and ruthenium oxide supported thereon, transmission electron microscope (TEM) observation was conducted. The results revealed that fine ruthenium oxide particles having a particle diameter of about 0.6 to 1.0 nm are supported on the surface of the carbon particles. The results of fluorescent X-ray analysis revealed that the support amount of ruthenium oxide is 5.97% by weight. The average particle diameter and each support amount of the fine ruthenium oxide particles and the fine platinum particles are shown in Table 1.

Using the resulting fine particles-supporting carbon particles, a power generating element for a fuel cell was produced in the same manner as in Example 1.

### Example 3

In the same manner as in Example 1, except that platinum was supported on ketjen black subjected to a nitric acid treatment in advance in a charge amount of 40% by weight through a liquid phase reduction (formalin reduction method), carbon particles comprising platinum and ruthenium oxide supported thereon were obtained. In the same manner as in Example 1, an aqueous solution containing picolinic acid complex ions of ruthenium was prepared by dissolving 1.35 g of ruthenium chloride in 300 ml of water and adding picolinic acid in the amount of 2 equivalents based on ruthenium ions.

With respect to the thus obtained carbon particles comprising platinum and ruthenium oxide supported thereon, transmission electron microscope (TEM) observation was conducted. The results revealed that fine platinum particles having a particle diameter of about 3 to 4 nm and fine ruthenium oxide particles having a particle diameter of about 0.6 to 1.0 nm are supported on the surface of the carbon particles. The results of fluorescent X-ray analysis revealed that the support amount of platinum is 37% by weight and the support amount of ruthenium oxide is 4.01% by weight. The particle diameter and each support amount of the fine ruthenium oxide particles and the fine platinum particles are shown in Table 1.

Using the resulting fine particles-supporting carbon particles, a power generating element for a fuel cell was produced in the same manner as in Example 1.

### Example 4

In the same manner as in Example 1, except that platinum and ruthenium were supported on ketjen black subjected to a nitric acid treatment in advance in a charge amount of 50% by weight and 20% by weight, respectively, through a liquid phase reduction (formalin reduction method), carbon particles comprising platinum and ruthenium oxide supported thereon were obtained.

With respect to the thus obtained carbon particles comprising platinum and ruthenium oxide supported thereon, transmission electron microscope (TEM) observation and measurement. using an energy-dispersive fluorescent X-ray analyzer (EDX) were conducted. The results revealed that fine platinum particles having a particle diameter of about 3 to 4 nm and fine ruthenium oxide particles having a particle diameter of about 0.8 to 1.0 nm are supported on the surface of the carbon particles. The results of fluorescent X-ray analysis revealed that the support amount of platinum is 49.5% by weight and the support amount of ruthenium oxide is 19.41% by weight. The results of XPS analysis revealed that about half of the metallic ruthenium exists in the form of ruthenium oxide. The average particle diameter and each support amount of the fine ruthenium oxide particles and the fine platinum particles are shown in Table 1.

Using the resulting fine particles-supporting carbon particles, a power generating element for a fuel cell was produced in the same manner as in Example 1.

### Comparative Example 1

In the same manner as in Example 1, except that a platinum-supporting carbon “10E50E” (trade name) manufactured by Tanaka Kikinzoku Kogyo Co., Ltd. was used as the catalyst in the negative electrode layer, a fuel cell power generating element was produced.

The support amount of platinum of this power generating element was 5.0 mg/cm² in the positive electrode layer, and was 2.0 mg/cm² in the negative electrode layer.

### Comparative Example 2

3.0 g of a platinum-supporting carbon “10E50E” manufactured by Tanaka Kikinzoku Kogyo Co., Ltd. was dipped in a solution prepared by dissolving 1.35 g of ruthenium chloride in 30 ml of water for one day and night. Herein, the support concentration of ruthenium was set to 30% by weight calculated as ruthenium oxide. After dipping, the platinum-supporting carbon was dried at 90° C. and heated in air at 270° C. for one hour to obtain carbon particles comprising platinum and ruthenium oxide supported thereon.

With respect to the resulting fine platinum and ruthenium oxide particles-supporting carbon particles, transmission electron microscope (TEM) observation was conducted. The results revealed that fine ruthenium oxide particles having a particle diameter of about 2.6 nm are supported on the surface of carbon particles. The results of fluorescent X-ray analysis revealed that the support amount of ruthenium oxide is 24.50% by weight.

Using the resulting fine platinum and ruthenium oxide particles-supporting carbon particles, a power generating element for a fuel cell was produced in the same manner as in Example 1.

### Comparative Example 3

In the same manner as in Example 1, except that a platinum-ruthenium alloy-supporting carbon “61E54” (trade name) comprising 54% bymass of an alloy of platinum and ruthenium (mass ratio of alloy: 3:2) manufactured by Tanaka Kikinzoku Kogyo Co., Ltd. was used as the catalyst in the negative electrode layer, a power generating element for a fuel cell was produced. With respect to this catalyst, XPS analysis was conducted. The results revealed that ruthenium exists in the state of an alloy and also a portion thereof exists in the form of ruthenium oxide.

The support amount of platinum of this power generating element was 5.0 mg/cm² in the positive electrode layer, and was 2.0 mg/cm² in the negative electrode layer. The support amount of ruthenium in the negative electrode layer was 1.33 mg/cm².

### <Fuel Cell Evaluation Test>

Each of the power generating elements for a fuel cell of the above respective Examples and Comparative Examples was assembled into a unit cell for evaluation of a fuel cell, together with a gas diffusion layer which also serves as a current collector, and then an evaluation test was conducted. FIG. 2 is a schematic sectional view showing the state before the respective components of the unit cell for evaluation of a fuel cell are assembled. At both sides of a power generating element for a fuel cell 5, a diffusion layer 6 composed of a carbon paper is disposed, and a seal material 7 composed of a silicone rubber is disposed around the diffusion layer. Furthermore, at both sides of the seal material 7, a positive electrode current collector plate 8 made of stainless steel provided with an oxygen flow-in port 10, and a negative electrode current collector plate 9 made of stainless steel provided with a fuel supply port 11 are provided. A fuel tank 12 containing a liquid fuel 13 stored therein is provided outside the negative electrode current collector plate 9.

The evaluation was conducted using oxygen in air as an oxidizer and using a 15 mass % methanol aqueous solution as a liquid fuel. The amount of platinum used was 2 mg/cm² in the negative electrode, and was 5 mg/cm² in the positive electrode. A unit cell for evaluation of a fuel cell was discharged at a cell temperature of 25° C. and maximum power density was measured. The maximum power density of a unit cell for evaluation is shown in Table 1 as the evaluation results. In this case, as the maximum power density becomes higher, the characteristics become better.

The measurement results in the above respective Examples and Comparative Examples are shown in Table 1. The average particle diameter of supported fine particles (for example, platinum and ruthenium oxide) is the average of the particle diameters measured by observing a TEM micrograph taken at a magnification of 1,000,000× using 30 particles, and the average particle diameter of supported fine particles-supporting carbon particles is the average of particle diameters measured by observing a TEM micrograph taken at a magnification of 200,000× using 30 particles.

TABLE 1

| | Calculated value | | | | Average particle | |
|---|---|---|---|---|---|---|
| | of amount of Ru | Analyzed value of | Average particle | Average particle | diameter of | Maximum power |
| | charged*3 | RuO₂ supported*4 | diameter of RuO₂ | diameter of platinum | carrier carbon | density |
| | (% by weight) | (% by weight) | supported (nm) | supported (nm) | (nm) | (mW/cm²) |
| Example 1 | 20 | 4.07 | 0.7 | 3 | 32.2 | 41 |
| Example 2 | 40 | 5.97 | 0.8 | 3.1 | 31.9 | 45 |
| Example 3 | 20 | 4.01 | 0.7 | 3.6 | 32.1 | 40 |
| Example 4 | 20 | 19.43 | 0.99 | 3.8 | 39.0 | 44 |
| Comparative | *1 | *1 | *1 | 3.2 | 32.3 | 11 |
| Example 1 | | | | | | |
| Comparative | 25 | 24.50 | 2.6 | 3.3 | 32.2 | 32 |
| Example 2 | | | | | | |
| Comparative | *1 | *1 | *2 4.2 | *2 4.2 | 30.8 | 34 |
| Example 3 | | | | | | |

*1: Numerical values in Comparative Example 1 and Comparative Example 3 respectively represent the support amount and the average particle diameter of a sample comprising only platinum supported thereon and a sample comprising platinum-ruthenium alloy particles supported thereon in advance.
*2: Average particle diameter of a platinum-ruthenium alloy.
*3: Value of the charge amount of ruthenium calculated as ruthenium oxide.
*4: Analytical value of supported ruthenium oxide.

As is apparent from Table 1, since oxidized supported particles of ruthenium have a predetermined average particle diameter, the respective Examples could achieve power density which is by far higher than that of Comparative Example 1 of particles comprising only platinum supported thereon. This is considered to be the result of CO poisoning of a platinum catalyst being prevented by ruthenium oxide. Furthermore, these Examples could achieve power density which is higher than that of Comparative Example 2 in which the average particle diameter of the supported ruthenium oxide is more than 1 nm, and Comparative Example 3 in which a platinum-ruthenium alloy is used.

Namely, when carbon particles comprising platinum and fine ruthenium oxide particles having an average particle diameter of 1 nm or less supported thereon are used, it was possible to achieve power which is the same as or higher than that in the case of using carbon particles comprising a platinum-ruthenium alloy supported thereon, although the amount of ruthenium drastically decreased. Residual ruthenium in the solution corresponding to a difference between the charge amount and the support amount of ruthenium can be regenerated by subjecting to a treatment known to those skilled in the art and also can be reused so as to produce the particles of the present invention.

Also, it could be confirmed that the effect of supporting ruthenium oxide is clear compared to the case of using carbon particles comprising only platinum supported thereon (Comparative Example 1).

The XPS analysis results revealed that at least a portion of the ruthenium metal or the platinum-ruthenium alloy exists as ruthenium oxide with respect to all the Examples. It is considered that, with respect to the Comparative Examples, since a promoter does not exist when only platinum is supported, platinum poisoning occurs during power generation and thus sufficient power could not be obtained.

### INDUSTRIAL APPLICABILITY

It becomes possible to achieve a remarkable reduction in the amount of ruthenium supported, which was one of the major problems to be solved so as to put a fuel cell into practical use, by using carbon particles comprising platinum and ruthenium oxide having a predetermined average particle diameter as a catalyst for an electrode.

Similarly, carbon particles comprising nano-size platinum and ruthenium oxide supported thereon can be applied as a catalyst for various purposes such as fuel cells, purification of an automobile exhaust, NOx reduction, antistatic additives of magnetic recording media, and antibacterial purposes.

1-11. (canceled)

12. Particles comprising at least carbon particles, platinum and ruthenium oxide, wherein the carbon particles support platinum and ruthenium oxide having an average particle diameter of 1 nm or less.

13. The particles according to claim 12, wherein the amount of ruthenium oxide supported on the carbon particles is from 1 to 25% by weight.

14. The particles according to claim 12 or 13, wherein the amount of platinum supported on the carbon particles is from 1 to 50% by weight.

15. The particles according to any one of claims 12 to 13, wherein the platinum has an average particle diameter of 1 to 5 nm.

16. The particles according to any one of claims 12 to 13, wherein the carbon particles have an average particle diameter of 20 to 70 nm.

17. The particles according to any one of claims 12 to 13, which have an average particle diameter of 10 to 80 nm.

18. A power generating element for a fuel cell, comprising the particles according to any one of claims 12 to 13 as a catalyst for an electrode.

19. The power generating element for a fuel cell according to claim 18, wherein the electrode is at least a negative electrode.

20. The power generating element for a fuel cell according to claim 18, wherein the electrode includes a negative electrode and a positive electrode.

21. A method for producing the particles according to any one of claims 12 to 13, which comprises a step of dispersing platinum-supporting carbon particles comprising platinum having an average particle diameter of 1 to 5 nm supported on carbon particles having an average particle diameter of 20 to 70 nm in a solution containing complex ions of ruthenium, thereby adsorbing the complex ions of ruthenium on the platinum-supporting carbon particles.

22. The method according to claim 21, which further comprises a step of drying the platinum-supporting carbon particles, thereby depositing fine ruthenium oxide particles on the surface of the platinum-supporting carbon particles.
